(19) United States
(12) Patent Application Publication
(10) Pub. No.: US 2003/0074307 A1
(43) Pub. Date: Apr. 17, 2003

(54) Machine-implementable-project finance analysis and negotiating tool, software and system

(76) Inventor: Wilfried A. Maestle, Washington, DC (US)

Correspondence Address: Crowell & Moring, L.L.P., P.O. Box 14300, Washington, DC, 20044-4300, US

(21) Appl. No.: 09/966,114

(22) Filed: Oct. 1, 2001

Related U.S. Application Data
(63) Continuation-in-part of application No. 09/781,964, filed on Feb. 14, 2001.
(63) Continuation-in-part of application No. 09/676,248, filed on Sep. 29, 2000.

(51) Int. Cl. G06F 17/60

(52) U.S. Cl. 705/38

(57) ABSTRACT

A financial simulation computer program product and method to generate a graphic user interface at a workstation which creates a project preparation, negotiating, and testing environment using standard project finance tools. A computer usable medium having computer-readable program code is embodied in a medium for generating financial statements, financial data, charts, graphs and reports using the standard project finance tools. The product and method allows the user to apply cash from the cash account to close a financing gap. Two interest earning accounts can be specified to deposit surplus cash. Furthermore, the user can draw down a loan to close an existing financing gap up to a loan maximum according to the position of the loan in a loan rank hierarchy. The user can draw down a loan to close a percentage of an existing financing gap. Through automatic iterations it can be ensured that sufficient loan funds are disbursed for a selected of cash flow position to be at least zero during a selected time period. The product and method allow the user to simulate one of a coupon bond, a zero coupon bond, a revenue bond or a specially customized bond (scalable to more bonds).

### CROSS REFERENCE TO RELATED APPLICATIONS

This application is a continuation-in-part of my patent application filed on Sep. 29, 2000 under Ser. No. 09/676,248 (referred to in the following as “the Parent Application”), the contents of which are herein incorporated by reference and of my Continuation-In-Part application filed on Feb. 14, 2001. under Ser. No. 09/781,964. (referred to in the following as the CIP Application), the contents of which are also herein incorporated by reference.

### COMPUTER PROGRAM LISTING APPENDIX

I attach on CDROM, as a supplement to the first Microfiche Appendix of the Patent Application and the modifications/extensions to my computer program listing submitted with the CIP Application, further modifications/extensions to my computer program listing. I further attach on CDROM flow charts constituting a supplement to the second Microfiche Appendix (Flow Chart and Graph Appendix of the Patent Application) of the Parent Application and to my CIP Application.

### BACKGROUND OF THE INVENTION

In the PFANT machine-implementable project finance analysis and negotiating tool described in the Parent Application, general-purpose loans could be used to disburse loan funds according to a manually designed disbursement schedule, or to finance total capital expenditure costs, categories, single contracts or parts thereof. While such financing capabilities are highly useful, financial modelers are sometimes confronted with the need to close a financing gap that remains after free cash flow from sales, paid in capital or other loan sources has been applied. To date, there exists no project finance software package with an easy-to-use graphical user interface that creates a project preparation, negotiating and testing environment with the standard project finance tools (debt service reserve accounts, sweep, stand-by loans, deferral credits for inputs and off-take fees, input price as a function of sales price) that allows to draw down loans up to their respective maximum amounts according to a ranking freely determined by the user, nor does such a software package exist that permits to use such loans to automatically finance a percentage of a remaining financing gap.

The PFANT tool described in the Parent Application features typical loan financing instruments used in project finance deals. While bank loans are often used to inject loan funds into project companies, it is not uncommon to issue a bond to such end. To date, there exists no project finance software package with an easy-to-use graphical user interface that creates a project preparation, negotiating and testing environment with the standard project finance tools that allows a non-financial modeler to simulate the issuing of a bond.

The PFANT tool described in the Parent Application allows the user to pay dividends on earnings and reduce the cash account accordingly. While this provides general program functionality, in some situations it might be desirable to apply cash in the cash account to close a possible financing gap or to invest surplus cash in interest earning instruments. To date, there exists no project finance software package with an easy to use graphical user interface that creates a project preparation, negotiating and testing environment with the standard project finance tools that allows the use of surplus cash for financing purposes or to deposit such cash in interest earning accounts.

### SUMMARY OF THE INVENTION

In addition to the capabilities of the PFANT tool, as fully described in the Parent Application in the CIP Application, the upgraded PFANT tool as described herein allows the user to:

draw down general-purpose loans to close a financing gap up to their respective maximum loan amounts according to a freely selectable and freely changeable ranking;

use general-purpose loans to close a freely selectable percentage of a financing gap;

use a standard coupon, zero coupon, revenue or specially customized bond to loan finance a project finance deal;

use surplus cash sitting in the cash account to close the financing gap of a later period;

deposit surplus cash sitting in the cash account for a freely selectable period into an interest earning account.

This present invention achieves a major step forward in financial modeling technique.

### BRIEF DESCRIPTION OF SUPPLEMENTAL DRAWINGS

FIG. 1 is a representative flow chart from the general-purpose loan data subset showing the routine used to calculate the maximum available rank position.

FIG. 2 is a representative flow chart from the general-purpose loan data subset showing the routine that writes the percentage of the financing gap that is to be closed.

FIGS. 3A and 3B are representative flowchart from the bond data subset showing the routine used to write the bond data subset.

FIG. 4 is a representative flowchart from the close the financing gap data subset showing the routine used to apply cash to close a financing gap.

FIG. 5 is a representative flow chart from the surplus cash investment data subset showing the routine to deposit surplus cash.

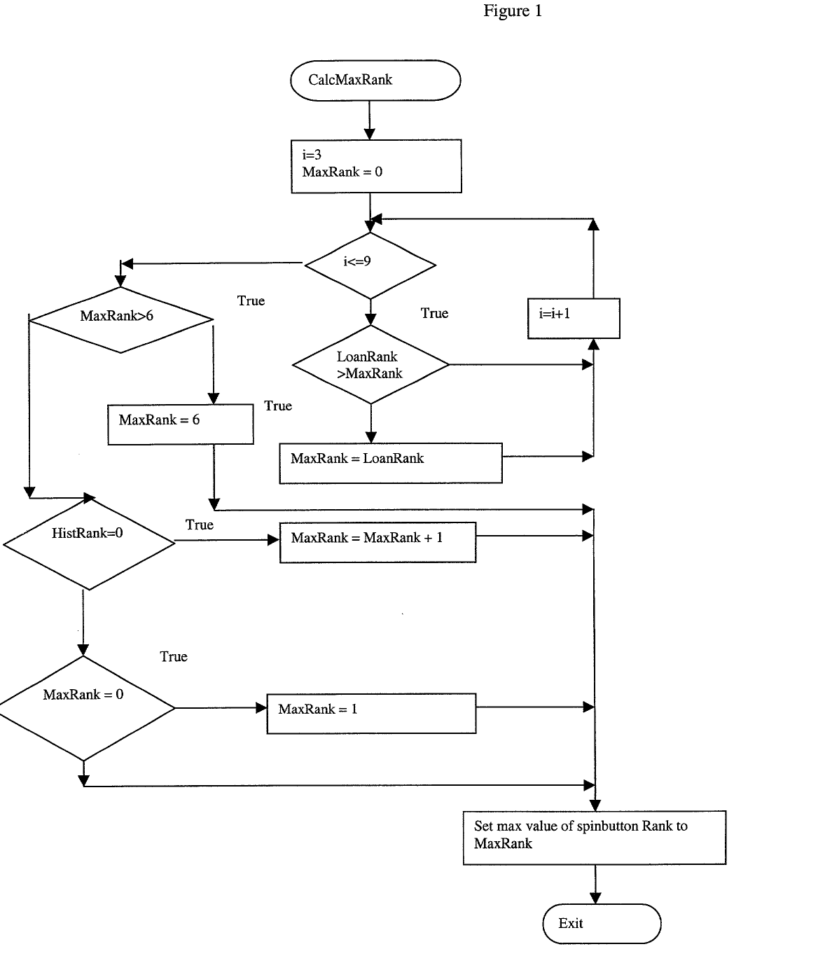

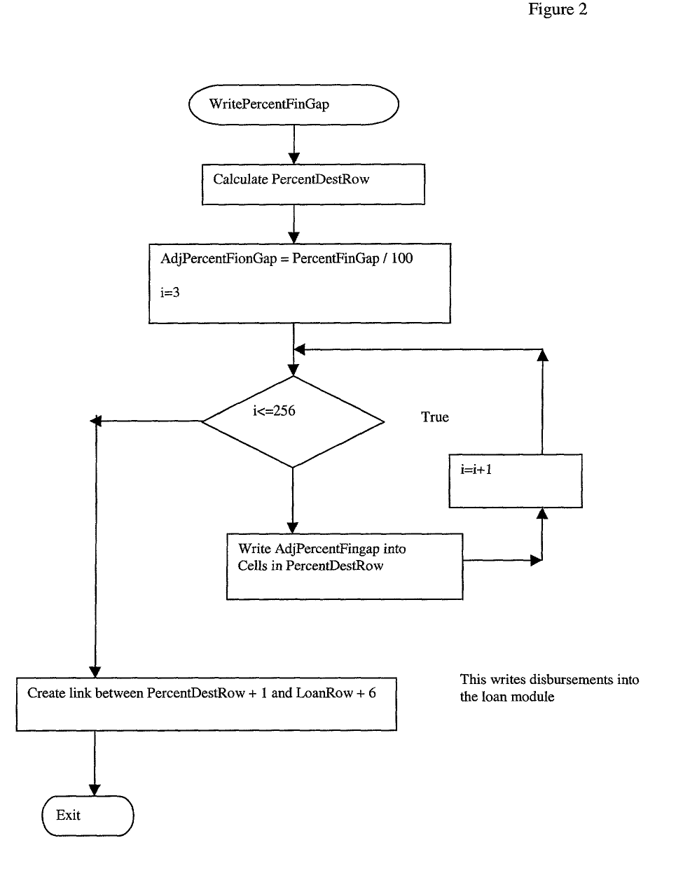

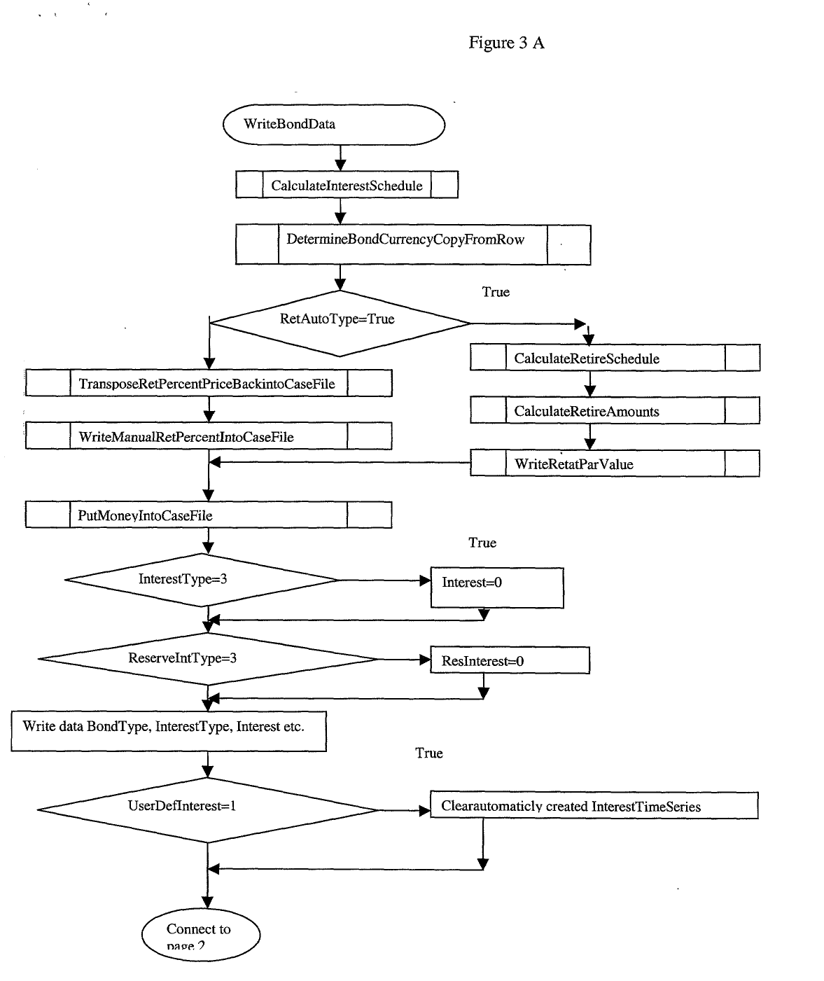

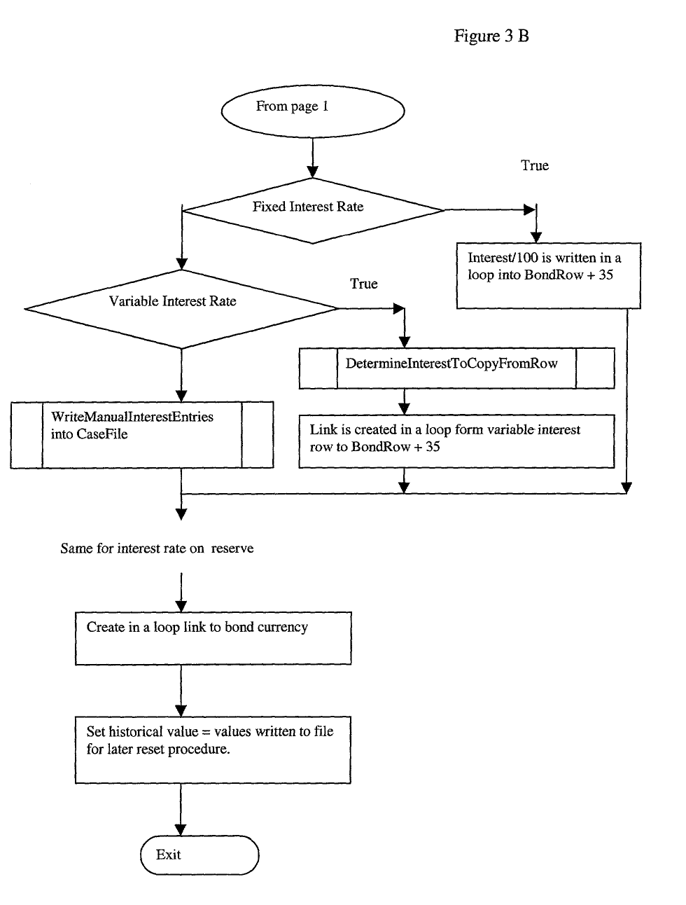

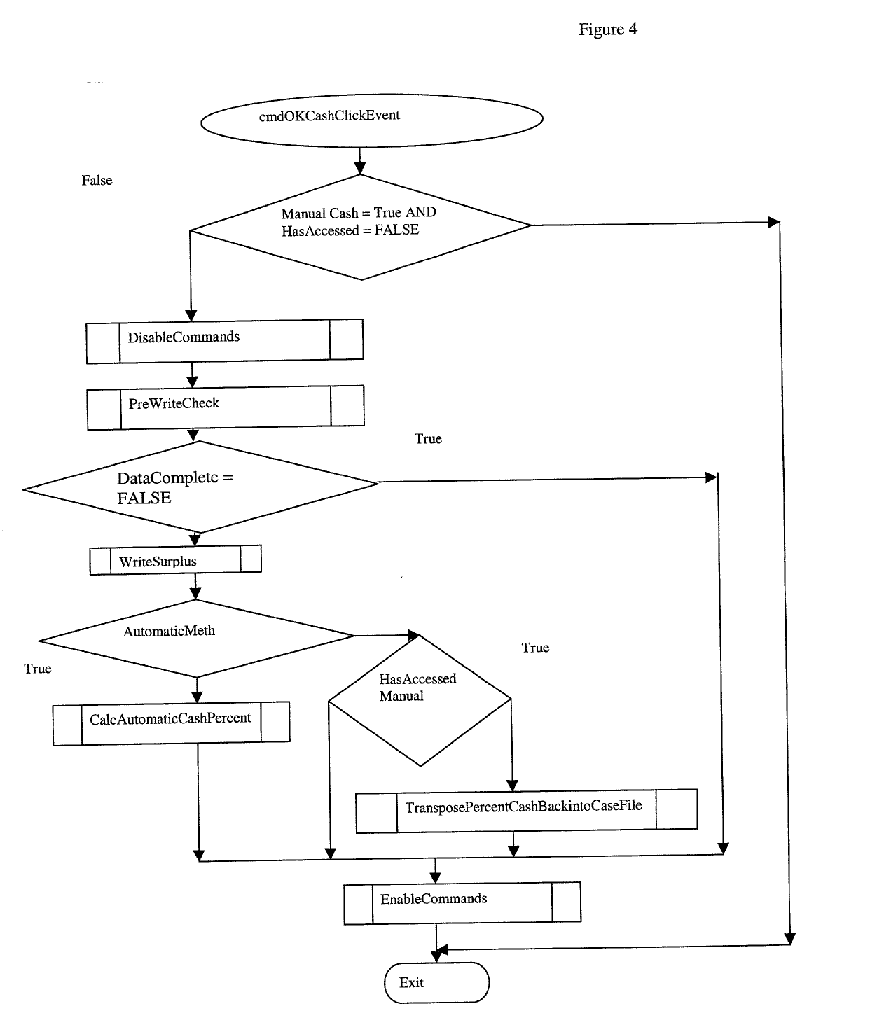

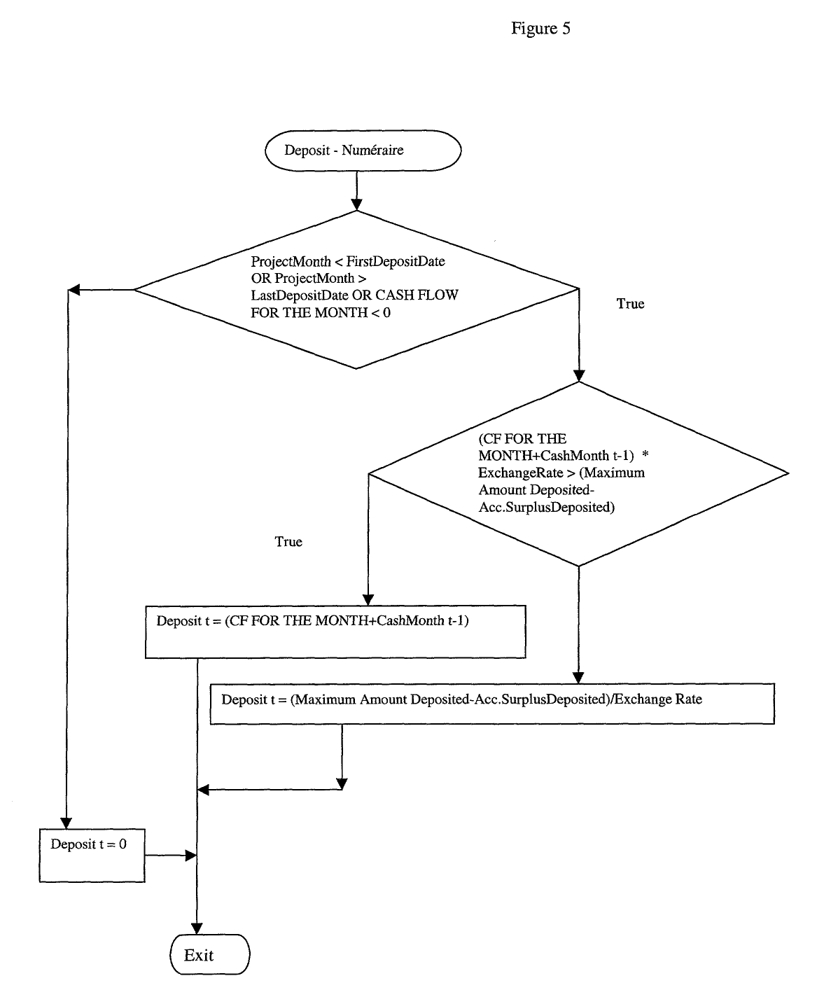

### DETAILED DESCRIPTION OF THE DRAWINGS

I am defining below the additional terms used throughout and in a manner which I believe to be generally consistent with normal and customary usage. To the extend there are any discrepancies, the following terminology should control the interpretation of my description.

Furthermore, a more complete description of the routines is found in the CD Appendix containing the supplement to the second Microfiche Appendix (Flow Chart and Graph Appendix of the Parent Application), notwithstanding the fact that the essential disclosure to enable a person of ordinary skill to make and use the invention is fully described herinbelow.

Supplement to Terminology of the Parent Application

Bond

A bond is a promise to pay the face value of the bond at the maturity date.

Carrying Value

If the face interest rate of a bond exceeds the market interest rate for a comparable bond the bond is normally sold at a premium. The premium is treated as interest received in advance. The premium is used to adjust the bond interest rate and is amortized until bond maturity. The unamortized part of the premium is added in the balance sheet to the face value of the bond to get the current carrying value of the bond. If the face interest rate is below the market interest rate for a comparable bond, the bond is normally sold at a discount. The discount is an interest expense that is amortized over the lifetime of the bond. In the balance sheet the unamortized discount is subtracted from the face value of the bond to get the current carrying value of the bond.

Coupon Bond

Bond that pays interest, usually in half-yearly installments, as stated on the coupon. The coupon is the periodic interest payment of the bond.

Par Value

The par value is the maturity value of a bond.

Retirement

Repayment of a bond. Retirement often starts after a deferment period.

Revenue Bond

Bond that pays interest if the issuer makes a profit. Unpaid interest is accumulated and paid at interest payment dates once the project company is again profitable.

Sinking Fund Provision

Sinking fund provisions often require the issuer to retire a certain amount of the bond-debt per year. This can be done through calls, decided by lottery or through buy backs of the debt in the bond market.

Zero Coupon Bond

Bond that pays no interest.

I. Supplement to General Overview

The PFANT describes each project finance deal by a set of data that the user enters into a case file spreadsheet. A list of the variables comprising such a set of data was submitted in Table I. of the Parent Application. A list of supplementary data required to accommodate the enhanced general-purpose loan draw-down, bond financing and surplus cash financing and investment capabilities is found in the following supplement to Table I.

SUPPLEMENT TO TABLE I.

| | | | |
|---|---|---|---|
| Data | Optional-Required | Default | Impact of Default |

Loans

| | | | |
|---|---|---|---|
| Financing Option | Optional | Total Capex | Total Capex or |
| Rank | | | percentage |
| | | | thereof financed. |
| Percent of Gap | Optional | Total Capex | Total Capex or |
| | | | percentage |
| | | | thereof financed. |
| Max. Amount | Required with | 0 (zero) | Loan not utilized. |
| | option Rank and | | |
| | Percent of Gap | | |
| Max. Interest | Required with | 0 (zero) | No interest |
| Capitalized | option Rank and | | capitalized. |
| | Percent of Gap | | |
| Rank for draw | Required with Rank | 1 (one) when | New loans are |
| down | | first loan | assigned the next |
| | | is entered. | available loan |
| | | | rank in the rank |
| | | | hierarchy. |

Reiterations for Percent of Gap Financing

| | | | |
|---|---|---|---|
| Close Gap-Cash | Optional | None | No cash flow |
| flow type | | | targeted to be at |
| | | | least zero. |
| First Month | Required | 1 | Cash flow target |
| | | | to be at least |
| | | | zero starts in |
| | | | month 1. |
| Last Month | Required | 1 | Cash flow target |
| | | | to be zero ends |
| | | | in month 1. |
| Number of | Required | 0 (zero) | No iterations. |
| Iterations | | | |

Bond

| | | | |
|---|---|---|---|
| Bond Currency | Required | Numéraire | Bond is issued in |
| | | | unit of account. |
| Option Bond | Required | Standard | Only fixed or user |
| Type | | Coupon | defined interest |
| Standard Coupon | | Bond | rates available. |
| Bond | | | |
| Zero Coupon | | | |
| Bond | | | |
| Revenue Bond | | | |
| Customized Bond | | | |
| Issue-Project | Required | 1 | Bond issued in |
| Month | | | Project Month 1. |
| Maturity-Project | Required | 5 | All bond debt has |
| Month | | | to be repaid at the |
| | | | end of month 5. |
| Par Value | Required | 0 (zero) | Retirement value |
| | | | is nil. No |
| | | | liability generated |
| | | | in balance sheet. |
| Money received | Optional | Value zero. | No funds |
| | | | mobilized. |
| User defined | Optional | Not checked. | Interest is |
| Interest on Bond | | | automatically |
| | | | generated. |
| Interest Rate | Optional | Fixed | Interest Rate is |
| | | Interest Rate | fixed until |
| | | | maturity. |
| Select Variable | Required with | Project | Default interest |
| Interest Rate | option Variable | Default | Rate applies to |
| | Interest Rate | Interest Rate | the bond. |
| % of Interest p.a. | Required with Fixed | 0 (zero) | No interest paid. |
| | Interest Rate | | |
| Basis points | Required with | 0 | No basis points |
| (+) or (−) | Variable Interest | | added or |
| | Rate | | subtracted from |
| | | | reference variable |
| | | | interest rate. |
| Interest | Required | Standard | Year has 365 |
| Calculation | | | days. |
| Method | | | |
| No. of Months | Required | 6 | Interest is paid six |
| Interest is paid | | | months in arrears. |
| Arrears | | | |
| Fees | Optional | 0 | No fees. |
| First Retirement | Required | 5 | First debt |
| Month | | | retirement in |
| | | | month 5. |
| Option | Selection Required | Automatic | Debt retirement |
| Retirement | | Retirement | automatically |
| | | Plan | generated. |
| Retirement | Required with | 6 | Debt retired in |
| Frequency | Automatic | | equal installments |
| | Retirement Plan | | every six months. |
| Reserve Principal | Optional | Not checked | No reserve for |
| | | | retirement of |
| | | | principal |
| | | | generated. |
| Reserve Interest | Optional | Not checked | No reserve for |
| | | | retirement of |
| | | | interest generated. |
| User defined | Optional | Not checked | No user defined |
| Reserve | | | reserve. |
| Interest Rate | Optional | Fixed | Interest Rate is |
| Reserve | | Interest Rate | fixed until |
| | | Reserve | maturity. |
| Select Variable | Required with | Project | Project default |
| Interest Rate- | Variable Interest | default | variable interest |
| Reserve | Rate | variable | rate applies to |
| | | interest rate. | reserve. |
| % of Interest p.a. | Required with Fixed | 0 (zero) | Interest is zero. |
| Reserve | Interest Rate | | |
| Basis points | Required with | 0 (zero) | No basis points |
| (+) or (−) Reserve | Variable Interest | | added or |
| | Rate | | subtracted from |
| | | | reference variable |
| | | | interest rate. |
| Interest | Required | Standard | Year has 365 |
| Calculation | | | days. |
| Method-Reserve | | | |

Use Surplus Cash to close Financing Gap

| | | | |
|---|---|---|---|
| Surplus Financing | Required | Automatic | Percent time |
| Option | | | series |
| | | | automatically |
| | | | generated. |
| % of Surplus | Required with | 0 (zero) | No cash applied |
| Cash used for | Automatic Surplus | | to close the |
| Financing | Financing | | financing gap. |
| First Surplus | Required | 1 | Use of surplus |
| Month | | | cash starts in |
| | | | month 1. |
| Last Surplus | Required | 1 | Use of surplus |
| Month | | | cash ends in |
| | | | month 1. |

Interest earning Account (IAC)

| | | | |
|---|---|---|---|
| IAC Name | Required | Empty | No access to |
| | | | account. |
| IAC Currency | Required | Numéraire | Surplus cash is |
| | | | invested in units |
| | | | of numéraire. |
| Interest option | Required | Fixed | Interest rate is |
| | | Interest Rate | fixed. |
| Select Variable | Required with | Default | Account uses |
| Interest Rate | option Variable | project | project variable |
| | Interest Rate | variable | interest rate. |
| | | interest rate. | |
| Interest p.a. % | Required with fixed | 0 | No interest. |
| | interest rate | | |
| Basis points | Required with | 0 | No basis points |
| (+) or (−) | variable interest | | added to |
| | rate. | | reference variable |
| | | | interest rate. |
| Interest | Required | Standard | Year has 365 |
| Calculation | | | days. |
| Method | | | |
| No. of Months | Required | 6 | Interest is paid |
| Interest is paid | | | six months in |
| in Arrears | | | arrears. |
| % of Interest | Optional | 0 (zero) | No interest |
| capitalized. | | | capitalized. |
| First | Required | 1 | Disbursements |
| Disbursement | | | into IAC start |
| Month | | | in month 1. |
| Last | Required | 1 | Disbursements |
| Disbursement | | | into IAG end |
| Month | | | in month 1. |
| Investment | Optional | Max. | Cash is first |
| Method | | Amount | invested in IAC |
| | | | 1 until maximum |
| | | | amount is |
| | | | reached. |
| | | | (Alternative: |
| | | | Percent of Cash |
| | | | Surplus). |
| Max. Amount | Required with Max. | 0 (zero) | No cash invested |
| | Amount investment | | in IAC under |
| | method. | | consideration. |
| % of Surplus | Required with | 0 (zero) | No cash deposited |
| deposited. | Percent of Cash | | in IAC under |
| | Surplus Investment | | consideration. |
| | Method. | | |

II. Enhanced General-Purpose Loan Capabilities

The user can use the options Rank and Percent of Financing Gap in addition to the previous financing options (Total Capex, Site, Buildings, Equipment, Pre-Production Costs).

A. Draw Down of General-Purpose Loans up to Maximum Amounts According to Rank Position

After having selected an individual loan record into the graphical user interface, the user can select the option Rank. She can enter the Maximum Amount that the PFANT is to disburse under the loan to close a financing gap. She can further enter the Maximum Interest amount up to which interest on the loan is to be capitalized. The Maximum Amount plus the Maximum Interest to be capitalized are equal to the possible maximum total loan utilization. The user can set and change at will the rank position for loans that are ruled by the option Rank. To close a financing gap after other financing means have been exhausted, the PFANT draws down the loan with the lowest rank position (1) first and then calls upon higher ranks in sequential order.

B. Use of General-Purpose Loan to close a Financing Gap

After having called an individual loan record into the graphical user interface, the user can select the option Percent of Gap. She can enter the percentage of the financing gap to be closed with the loan, with the PFANT ensuring that not more than one hundred percent of the gap is closed by the loans governed by the Percent of Gap option. She can include in the financing gap to be closed interest and principal payments, and cause the PFANT to ensure through iterations that one of the following cash flows according to her choice is at least zero during the loan financing period:

Cash flow after Debt Service

Cash flow after DSRA+fill DSRA

Cash flow after Interest on DSRA

Cash flow after Draw-down of Stand-by Construction

Cash flow after Draw-down of Stand-by Repayment

Cash flow after Interest for Stand-by Construction

Cash flow after Interest for Stand-by Repayment

Cash flow after deferred Variable Costs

Cash flow after Interest deferred Variable Costs

Cash flow after deferred Fees

Cash flow for the Month

III. The Bond Data Subset

The bond allows the user to inject loan funds into the project company whenever she wants. The PFANT allows her to select either a standard coupon bond with a fixed interest rate, a zero coupon bond that pays no interest, a revenue bond with a fixed, variable or manually designed interest rate or a customized bond with a fixed, variable or manually designed interest rate. The revenue interest bond pays interest only, if the project company has been profitable since the last interest payment date. If the user wants to establish a different condition for interest payment, she can overrule the built-in interest feature and manually enter payments or formulas directly into the spreadsheet.

The user can tell the PFANT the number of months interest is paid in arrears and the PFANT automatically generates an interest payment date schedule. Interest is paid at interest payment dates only on the debt outstanding at the interest payment date (except if the interest rate is zero as is the case with a zero coupon bond).

(i) Bond-General

The user can choose any project currency as bond currency. Bond transactions are made in the bond currency. If the exchange rate changes, foreign exchange (forex) gains or losses result as more or less has to be repaid. The program calculates and accounts for forex gains or losses and accommodates the standard (year has 365 days) and the Euro (year has 360 days) interest method.

The user can issue the bond at par (face interest is equal to market interest), under par (face interest is lower than market interest rate) or over par (face interest is higher than market interest rate). If the bond is issued under par, the PFANT treats the discount as an additional interest expense that is amortized over the bonds lifetime. If the bond is issued over par, the PFANT treats the premium as interest earned in advance. The PFANT uses the premium to adjust the bond interest rate and amortizes the premium until bond maturity. The unamortized part of the premium is added in the balance sheet to the face value of the bond to get the current carrying value of the bond. If the face interest rate is below the market interest rate for a comparable bond, the bond is sold at a discount. The discount is treated as an interest expense that is amortized over the lifetime of the bond. The unamortized discount is subtracted from the face value of the bond to get the current carrying value of the bond in the balance sheet.

(ii) Retirement

The user can select the First Retirement and the Maturity month. She can either (1) automatically generate a retirement schedule with the debt retired at par value in equal monthly, quarterly, half-yearly or yearly installments from the First Retirement month to the Maturity month, or (2) she can manually design a retirement schedule by entering for each retirement month the percentage of the par value paid for each par unit of bond retired during that month and by entering the percentage of the total issued par value retired that month. The user can use the manual retirement feature to simulate retirement under par (creating a capital gain), at par or over par (causing a capital loss) to simulate bond market conditions and credit standing of the company in the market place. Further, she can convert outstanding bond debt into equity at any conversion rate.

(iii) Reserve

The user can choose to create a reserve for either retired principal and/or interest payments. The PFANT generates such a reserve in equal monthly step-ups to the next retirement date. The user can overrule the built-in reserve generating mechanism and can manually enter reserve amounts or formulas as she likes. Interest is paid on the amount held as reserve. She can opt for fixed, variable or manual interest rates for the reserve and in case of variable interest rates select one of up to eleven variable interest rates. The program accommodates the standard (year has 365 days) and the Euro (year has 360 days) interest method for interest payments on the reserve.

The PFANT in its present form is limited to one bond. However, the bond module is easily scalable and could be extended to two or more bonds if required by users. The changes to the graphical user interface would be minor.

IV. Use Surplus Cash to Close a Financing Gap

The user can generate manually or automatically a percentage time series for cash in the cash account to be used to close a financing gap. The PFANT applies the percentage of cash only if a financing gap exists.

V. Interest Earning Accounts/Securities

Interest earning Accounts (IAC) allow the user to deposit cash from the cash account into an interest earning account or security. The program generates deposit and withdrawal schedules. If the project ends before the monies placed in the IAC have been withdrawn, the IAC shows the amount in the account the month before the project ends. Interest payments then turn to zero. The account name identifies an individual record. The user can choose any project currency as account currency. Account transactions are made in the account currency. The program calculates and accounts for forex gains or losses, and accommodates the standard (year has 365 days) and Euro (year has 360 days) interest methods. The user can opt for a fixed, variable or manual interest rate. In case of a variable interest rate she can select any of the project variable interest rates and add or subtract basis points from the selected variable interest rate as the case may be. In case of a manual interest rate she can enter for each roll-over date an interest rate. The user can select the number of months interest is paid in arrears. The program allows the capitalization of interest up to and including the First Deposit Month.

(i) Deposits into the IAC

The user can:

a) either set a maximum amount up to which cash can be deposited into the IAC. The PFANT then fills first the IAC entered first and then the IAC entered second, or

b) determine the share of cash in the cash account that she wants to put into the IAC (e.g. 50%) and

c) choose the time slice she wants to put cash into the IAC (by setting the schedule for deposits into the account accordingly).

(ii) Withdrawal Methods

(a) Equal Installments

The user is allowed to harmonize payment dates for interest and principal. In case of equal installments, the first withdrawal date of principal is also made an interest payment date. However, if the time between installments and the number of months interest is paid in arrears differ, later interest and principal payment dates will not necessarily coincide.

Deposits into the IAC can be made during the withdrawal phase up to the Month of Last Withdrawal. The interest can be capitalized up to and including the first withdrawal month.

(b) Annuity

Payments into the IAC can be made until the last withdrawal installment (the annuity is recalculated). Interest can be capitalized up to and including the first withdrawal month.

The user can freely choose the number of months for interest to be paid in arrears during the cash deposit phase. Starting with the first withdrawal, however, principal and interest payment dates coincide.

The following description discloses an excerpt of a revised Chapter 6 (Loans, taking into account the increased draw-down up to a maximum according to rank position and close percentage financing gap capabilities) of the proposed user's guide. The description further discloses the new Chapters Bond and Cash Account of the proposed user's guide.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers,
means for allowing automatically generated or manual entry of and editing of capital expenditure time series for multiple contracts in multiple capital expenditure categories;
means for selecting a desired financing time horizon for each loan;
means for setting for each loan a percentage of capital expenditure time series to be financed,
means for automatically generating a loan disbursement time series, and
means for generating a loan disbursement time series independent of changes in capital expenditure and exchange rates based upon earlier automatically generated loan disbursement time series, and
means for automatically generating a loan disbursement time series to close a financing gap and limiting the total loan amount drawn down from a loan during the disbursement period by a total loan amount for that loan equal to a maximum amount disbursed for principal plus a maximum interest amount to be capitalized both as entered by the user, assigning a rank to a loan and ensuring that loans are drawn down according to their rank with the loan with rank one being drawn down first.

2. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers,
means for allowing automatically generated or manual entry of and editing of capital expenditure time series for multiple contracts in multiple capital expenditure categories;
means for selecting a desired financing time horizon for each loan;
means for setting for each loan a percentage of capital expenditure time series to be financed,
means for automatically generating a loan disbursement time series, and
means for generating a loan disbursement time series independent of changes in capital expenditure and exchange rates based upon earlier automatically generated loan disbursement time series, and
means for automatically generating a loan disbursement time series to close part or all of a financing gap with a loan and the total loan amount drawn down from such a loan during the disbursement period limited by a total loan amount for that loan equal to the total maximum amount for principal plus the maximum amount for interest to be capitalized both as entered by the user, assigning a percentage of the financing gap to be closed by that loan and ensuring that the loans assigned to close a percentage of the financing gap do not finance more than one hundred percent of such a financing gap.

3. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers,
means for allowing automatically generated or manual entry of and editing of capital expenditure time series for multiple contracts in multiple capital expenditure categories;
means for selecting a desired financing time horizon for each loan;
means for setting for each loan a percentage of capital expenditure time series to be financed,
means for automatically generating a loan disbursement time series, and
means for generating a loan disbursement time series independent of changes in capital expenditure and exchange rates based upon earlier automatically generated loan disbursement time series, and
means for selecting one of a coupon bond, zero coupon bond, revenue bond and specially customized bond to inject funds in a freely selectable project currency into the project company, allowing the user to inject such funds at face value, at a discount or at a premium and automatically calculating the carrying value of the bond and the net interest expense for each period over the lifetime of the bond.

4. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers,
means for allowing automatically generated or manual entry of and editing of capital expenditure time series for multiple contracts in multiple capital expenditure categories;
means for selecting a desired financing time horizon for each loan;
means for setting for each loan a percentage of capital expenditure time series to be financed,
means for automatically generating a loan disbursement time series, and
means for generating a loan disbursement time series independent of changes in capital expenditure and exchange rates based upon earlier automatically generated loan disbursement time series, and
means for using cash from the cash account to close a financing gap, allowing the user to enter the percentage of the surplus cash to be used and select the first and last month of the financing period and automatically generating a percentage time series and giving the user access to that time series for manual editing.

5. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers,
means for allowing automatically generated or manual entry of and editing of capital expenditure time series for multiple contracts in multiple capital expenditure categories;
means for selecting a desired financing time horizon for each loan;
means for setting for each loan a percentage of capital expenditure time series to be financed,
means for automatically generating a loan disbursement time series, and
means for generating a loan disbursement time series independent of changes in capital expenditure and exchange rates based upon earlier automatically generated loan disbursement time series, and
means for depositing cash from the cash account into interest earning accounts for a freely selectable depositing period allowing the user to select the account currency and selecting one of withdrawal methods equal installments or annuity and capitalizing interest paid on the account.

6. The computer program product as claimed in claim 1, wherein means is provided to change the rank position of a loan and to update all rank positions of other loans with a rank position assigned upon the deletion of a loan with a rank or the selection of a non-rank financing method for such a loan.

7. The computer program product as claimed in claim 2, wherein means is provided to allow the user to ensure that sufficient loan funds are disbursed to ensure that one of a
Cash flow after Debt Service
Cash flow after DSRA+fill DSRA (debt service reserve account filled to required level)
Cash flow after Interest on DSRA
Cash flow after Draw-down of Standby Construction
Cash flow after Draw down of Standby Repayment
Cash flow after Interest on Standby Construction
Cash flow after Interest on Standby Repayment
Cash flow after deferred Variable Costs
Cash flow after Interest deferred Variable Costs
Cash flow after deferred Fees (Off-taker)
Cash flow for the Month (after Interest deferred Off-taker)
is a least zero through a time slice inputted by user and in case of a Cash flow after DSRA+fill DSRA ensuring that the debt service reserve accounts are filled to their required levels.

8. The computer program product as claimed in claim 3, wherein means is provided to allow the user to enter in case of a coupon bond a fixed interest rate, in case of a revenue or customized bond to select one of a fixed interest rate, a freely selectable variable interest rate or a manual interest rate, while in case of a variable interest rate creating a link between a bond and variable interest rate and ensuring change of bond interest rate at appropriate rollover date with basis points added or subtracted as user inputs, and, in case of manual interest rate selection, giving access to entry fields to set manually interest rate at appropriate rollover dates not allowing changes between such dates ensuring that in case of a revenue bond interest is paid only if the project company makes a profit and not paid interest is paid at a later interest payment date once profitability is restored.

9. The computer program product as claimed in claim 3, wherein means is provided to allow the user to select the number of months interest is paid in arrears.

10. The computer program product as claimed in claim 3, wherein means is provided to allow the user to automatically generate a retirement plan with the retirement frequency selectable as one of monthly, quarterly, half-yearly or yearly ensuring that the debt is retired at face value.

11. The computer program product as claimed in claim 10, wherein means is provided for manual editing of a retirement plan, allowing the user to set for each month during a retirement period the percentage of the total face value amount of debt issued to be retired during that month and the percentage of the face value paid for a unit of face value retired permitting the user to simulate capital gains or losses resulting from debt retirement.

12. The computer program product as claimed in claim 3, wherein means is provided for automatically creating a reserve for bond debt retirement allowing the user to select one of fixed interest rate, variable interest rate or manual interest rate for interest paid on reserve.

13. The computer program product as claimed in claim 5, wherein means is provided for user selecting one of deposit of surplus cash up to a freely selectable maximum amount or deposit of percentage of surplus cash with the program ensuring that not more than one hundred percent of the surplus cash being deposited.

14. Method for implementing a machine-readable financial simulation computer program, comprising:
installing the program which is contained as computer readable code on a computer usable medium in a computer permitting entry of data representative of multiple contracts and multiple expenditure categories;
selecting a desired loan financing time horizon;
setting a percentage of a capital expenditure time series to be financed; and
generating a loan disbursement time series and disbursement schedule independent of changes in capital expenditures and in exchange rates; and
method for automatically generating a loan disbursement time series to close part of or all of a financing gap and limiting the total loan amount drawn down from a loan during the disbursement period by a total loan amount for that loan equal to a maximum amount disbursed for principal plus a maximum interest amount to be capitalized both as entered by the user, assigning a rank to a loan and ensuring that loans are drawn down according to their rank with the loan with rank one being drawn down first.

15. Method for implementing a machine-readable financial simulation computer program, comprising:
installing the program which is contained as computer readable code on a computer usable medium in a computer permitting entry of data representative of multiple contracts and multiple expenditure categories;
selecting a desired loan financing time horizon;
setting a percentage of a capital expenditure time series to be financed; and
generating a loan disbursement time series and disbursement schedule independent of changes in capital expenditures and in exchange rates; and
method for automatically generating a loan disbursement time series to close a financing gap with one or more loans and the total loan amount drawn down for a loan during the disbursement period limited by a total loan amount for that loan equal to the total maximum amount for principal plus the maximum amount for interest to be capitalized both as entered by the user, assigning a percentage of the financing gap to be closed by that loan and ensuring that the loans assigned to close a percentage of the financing gap do not finance more than one hundred percent of such a financing gap.

16. Method for implementing a machine-readable financial simulation computer program, comprising:
installing the program which is contained as computer readable code on a computer usable medium in a computer permitting entry of data representative of multiple contracts and multiple expenditure categories;
selecting a desired loan financing time horizon;
setting a percentage of a capital expenditure time series to be financed; and
generating a loan disbursement time series and disbursement schedule independent of changes in capital expenditures and in exchange rates; and
method for selecting one of a coupon bond, zero coupon bond, revenue bond and specially customized bond to inject funds in a freely selectable project currency into the project company, allowing the user to inject such funds at face value, at a discount or at a premium and automatically calculating the carrying value of the bond and the net interest expense for each period over the lifetime of the bond.

17. Method for implementing a machine-readable financial simulation computer program, comprising:
installing the program which is contained as computer readable code on a computer usable medium in a computer permitting entry of data representative of multiple contracts and multiple expenditure categories;
selecting a desired loan financing time horizon;
setting a percentage of a capital expenditure time series to be financed; and
generating a loan disbursement time series and disbursement schedule independent of changes in capital expenditures and in exchange rates; and
method for using cash from the cash account to close a financing gap, allowing the user to enter the percentage of the surplus cash to be used and select the first and last month of the financing period and automatically generating a percentage time series and giving the user access to that time series for manual editing.

18. Method for implementing a machine-readable financial simulation computer program, comprising:
installing the program which is contained as computer readable code on a computer usable medium in a computer permitting entry of data representative of multiple contracts and multiple expenditure categories;
selecting a desired loan financing time horizon;
setting a percentage of a capital expenditure time series to be financed; and
generating a loan disbursement time series and disbursement schedule independent of changes in capital expenditures and in exchange rates; and
method for depositing cash from the cash account into interest earning accounts for a freely selectable depositing period allowing the user to select the account currency and selecting one of withdrawal methods equal installments or annuity and capitalizing interest paid on the account.

19. The method as claimed in claim 14, further comprising changing the rank position of a loan and updating all rank positions of other loans with a rank position assigned upon the deletion of a loan with a rank or the selection of a non-rank financing method for such a loan.

20. The method as claimed in claim 15, further comprising ensuring that sufficient loan funds are disbursed to ensure that one of a
Cash flow after Debt Service
Cash flow after DSRA+fill DSRA
Cash flow after Interest on DSRA
Cash flow after Draw-down of Standby Construction
Cash flow after Draw down of Standby Repayment
Cash flow after Interest on Standby Construction
Cash flow after Interest on Standby Repayment
Cash flow after deferred Variable Costs
Cash flow after Interest deferred Variable Costs
Cash flow after deferred Fees (Off-taker)
Cash flow for the Month (after Interest deferred Off-taker)
is a least zero through a time slice inputted by user and in case of a Cash flow after DSRA+fill DSRA ensuring that the debt service reserve accounts are filled to their required levels.

21. The method as claimed in claim 16, further comprising allowing the user to enter in case of a coupon bond a fixed interest rate, in case of a revenue or customized bond to select one of a fixed interest rate, a freely selectable variable interest rate or a manual interest rate, while in case of a variable interest rate creating a link between a bond and variable interest rate and ensuring change of bond interest rate at appropriate rollover date with basis points added or subtracted as user inputs, and, in case of manual interest rate selection, giving access to entry fields to set manually interest rate at appropriate rollover dates not allowing changes between such dates ensuring that in case of a revenue bond interest is paid only if the project company makes a profit and not paid interest is paid at a later interest payment date once profitability is restored.

22. The method as claimed in claim 16, further comprising free selection of the number of months interest is paid in arrears.

23. The method as claimed in claim 16, further comprising automatically generating a retirement plan for debt with selection of a retirement frequency as one of monthly, quarterly, half-yearly or yearly ensuring that the debt is retired at face value.

24. The method as claimed in claim 16, further comprising manual editing of the retirement plan, allowing manual setting each month during a retirement period the percentage of the total face value of debt amount issued to be retired during that month and the percentage of the face value paid for a unit of face value retired permitting simulation of capital gains or losses resulting from debt retirement.

25. The method as claimed in claim 16, further comprising automatically creating a reserve for bond debt retirement allowing the user selection one of fixed interest rate, variable interest rate or manual interest rate for interest paid on reserve.

26. The method as claimed in claim 18, further comprising selection one of deposit of surplus cash up to a freely selectable maximum amount or deposit of percentage of surplus cash with the program ensuring that not more than one hundred percent of the surplus cash being deposited.
